(19) United States
(12) Patent Application Publication
(10) Pub. No.: US 2017/0056919 A1
(43) Pub. Date: Mar. 2, 2017

(54) MANUFACTURING APPARATUS FOR FIBER-REINFORCED COMPOSITE MATERIAL AND MANUFACTURING METHOD THEREOF

(71) Applicant: TOYOTA JIDOSHA KABUSHIKI KAISHA, Toyota-shi (JP)

(72) Inventors: Eiji ORISAKA, Nisshin-shi (JP); Fumio NOMIZO, Toyota-shi (JP)

(73) Assignee: TOYOTA JIDOSHA KABUSHIKI KAISHA, Toyota-shi (JP)

(21) Appl. No.: 15/244,329

(22) Filed: Aug. 23, 2016

(30) Foreign Application Priority Data
Sep. 2, 2015 (JP) 2015-172842

(51) Int. Cl. B05D 1/28; B05C 1/08

(52) U.S. Cl. CPC B05D 1/28; B05C 1/08

(57) ABSTRACT

A manufacturing apparatus for a fiber-reinforced composite material, comprising: a roller that is rotated to convey a fiber and impregnate the fiber with a resin, in order to manufacture the fiber-reinforced composite material from the fiber; a supply portion that is configured to supply the resin to a surface of the roller; a rotating shaft member that is connected with the roller; a bearing that is configured to support the rotating shaft member such that the rotating shaft member is rotated about an axial direction of the rotating shaft member, accompanied with rotation of the roller; a housing that has an intake port provided to take in a gas and an exhaust port provided to discharge the gas and that is configured to place part of the rotating shaft member and the roller inside thereof; and a blower that is configured to blow the gas from the intake port into the housing, wherein the gas taken in from the intake port is blown in a direction opposite to the bearing to at least part of the surface of the roller and is subsequently discharged out of the housing through the exhaust port.

### CROSS-REFERENCE TO RELATED APPLICATIONS

The present application claims priority from Japanese patent application P2015-172842 filed on Sep. 2, 2015, the content of which is hereby incorporated by reference into this application.

### BACKGROUND

Field

The present invention relates to manufacture of a fiber-reinforced composite material.

Related Art

JP S61-229536A discloses a technique that uses a roller to impregnate a fiber with a thermoplastic resin and thereby manufactures a fiber-reinforced composition. In the configuration disclosed in JP S61-229536A, a roller is surrounded by a housing.

In the technique using the roller for impregnation like the above prior art, the resin is atomized and scattered in the course of separating the fiber from the roller, so that inside of the housing is filled with the atomized resin. This causes a bearing provided to support the roller to be stained with the resin. The stained bearing is likely to interfere with rotation of the roller. By taking into account this problem, an object of the invention is thus to suppress the bearing from being stained with the resin.

### SUMMARY

In order to solve at least part of the above problem, the invention may be implemented by any of the following aspects.

According to one aspect of the invention, there is provided a manufacturing apparatus for a fiber-reinforced composite material. This manufacturing apparatus comprises a roller that is rotated to convey a fiber and impregnate the fiber with a resin, in order to manufacture the fiber-reinforced composite material from the fiber; a supply portion that is configured to supply the resin to a surface of the roller; a rotating shaft member that is connected with the roller; a bearing that is configured to support the rotating shaft member such that the rotating shaft member is rotated about an axial direction of the rotating shaft member, accompanied with rotation of the roller; a housing that has an intake port provided to take in a gas and an exhaust port provided to discharge the gas and that is configured to place part of the rotating shaft member and the roller inside thereof; and a blower that is configured to blow the gas from the intake port into the housing. The gas taken in from the intake port is blown in a direction opposite to the bearing to at least part of the surface of the roller and is subsequently discharged out of the housing through the exhaust port. The manufacturing apparatus of this aspect suppresses the bearing from being stained with the resin. This is because the atomized resin generated from the vicinity of the surface of the roller is flowed in the opposite direction to the bearing by the gas that is taken in from the intake port and is substantially free from the resin. This configuration accordingly suppresses the resin from approaching the bearing.

In the manufacturing apparatus for the fiber-reinforced composite material of the above aspect, the bearing may be placed outside of the housing, and the gas taken in from the intake port may be blown to a connection part of the housing and the rotating shaft member and subsequently be blown to the surface of the roller. In the manufacturing apparatus of this aspect, the bearing is placed outside of the housing, so that the resin is unlikely to adhere to the bearing. According to this configuration, the gas is blown to the connection part of the housing and the rotating shaft member from which the bearing is accessible. The resin is thus unlikely to adhere to the bearing.

In the manufacturing apparatus for the fiber-reinforced composite material of the above aspect, the housing may include a partition plate provided to separate inside of the housing. A space separated by the partition plate may be connected with the intake port. The rotating shaft member may be arranged to penetrate a through hole provided in the partition plate. At least part of the taken-in gas may be blown to the connection part and subsequently pass through the through hole to be blown to the roller. In the manufacturing apparatus of this aspect, the taken-in gas is blown to the roller, so as to efficiently heat the roller.

In the manufacturing apparatus for the fiber-reinforced composite material of the above aspect, the blower may beat the gas before blowing the gas. In the manufacturing apparatus of this aspect, the heated gas is blown to the roller, so as to heat the roller. In this configuration, there is accordingly no need to separately provide any additional heating device for controlling the temperature of the roller to a temperature suitable for impregnation.

In the manufacturing apparatus for the fiber-reinforced composite material of the above aspect, the blower may blow the gas discharged from the exhaust port into the intake port, so as to circulate the gas. This configuration allows for circulation of the heated gas and thereby reduces the amount of heat required for heating the gas.

In the manufacturing apparatus for the fiber-reinforced composite material of the above aspect, the housing may include a filter provided to adsorb the resin. The gas taken in from the intake port may pass through the filter and subsequently be discharged out of the housing through the exhaust port. This configuration decreases the resin released out of the housing.

In the manufacturing apparatus for the fiber-reinforced composite material of the above aspect, the bearing may be supported on a bearing base fixed to a surface of the housing. In this configuration, there is no need to provide any additional member for fixing the bearing base.

The invention may be implemented by any of various aspects other than those described above, for example, a manufacturing method of a fiber reinforced composite material.

### BRIEF DESCRIPTION OF DRAWINGS

FIG. 1 is a diagram illustrating the schematic configuration of a tow prepreg manufacturing apparatus;

FIG. 2 is a sectional perspective view illustrating an impregnation unit;

FIG. 3 is a sectional view illustrating the impregnation unit;

FIG. 4 is a sectional end view illustrating the impregnation unit;

FIG. 5 is a sectional end view illustrating another impregnation unit;

FIG. 6 is a sectional end view illustrating another impregnation unit;

FIG. 7 is a sectional end view illustrating another impregnation unit;

FIG. 8 is a sectional end view illustrating another impregnation unit;

FIG. 9 is a diagram illustrating a plurality of intake ports; and

FIG. 10 is a sectional end view illustrating another impregnation unit.

### DESCRIPTION OF EMBODIMENTS

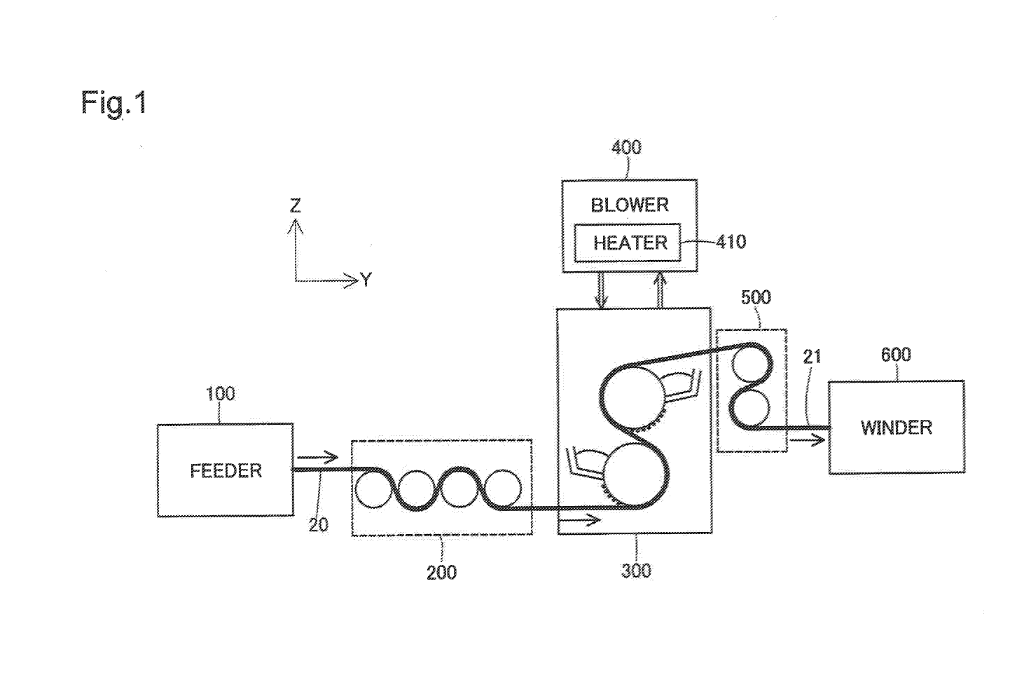

FIG. 1 is a diagram illustrating the schematic configuration of a manufacturing apparatus for fiber reinforced composite material 10. The manufacturing apparatus for fiber reinforced composite material 10 includes a feeder 100, a first roller unit 200, an impregnation unit 300, a blower 400, a second roller unit 500 and a winder 600.

The feeder 100 is also called creel. The feeder 100 is a device configured to feed out a tow 20. The tow 20 denotes a reinforcing fiber obtained by bundling one to several ten thousand filaments. The filament herein denotes a fiber bundle consisting of a large number of single fibers. The single fiber according to this embodiment is a PAN (polyacrylonitrile)-based carbon fiber and has thickness of 5 to 7 μm.

The first roller unit 200 includes a plurality of rollers provided to reduce the thickness of the tow 20 and extend the width of the tow 20 fed out from the feeder 100. Each of these rollers is configured to have a middle portion having a larger diameter than the diameters of respective end portions, so as to extend the width of the tow 20. Extending the width of the tow 20 enhances the efficiency of impregnation.

The impregnation unit 300 is a device provided to impregnate the tow 20 that has the width extended by the first roller unit 200, with a resin. Such impregnation of the tow 20 by the impregnation unit 300 provides a tow prepreg 21. The tow prepreg 21 is a type of fiber-reinforced composite material.

The blower 400 is configured to blow the air into the impregnation unit 300. The blown air passes through the impregnation unit 300 and is then discharged out of the impregnation unit 300. The blower 400 is also configured to take in the air discharged from the impregnation unit 300 and blow the intake air again into the impregnation unit 300. The blower 400 thus also serves as a circulator to circulate the air.

The blower 400 includes a heater 410. The heater 410 is an electric heater configured to heat the intake air. The blower 400 sends the heated hot air into the impregnation unit 300. The blower 400 thus also serves as a hot air generator to generate the hot air.

Sending the hot air into the impregnation unit 300 increases the internal temperature of the impregnation unit 300 to be higher than the ambient temperature. Increasing the internal temperature of the impregnation unit 300 to be higher than the ambient temperature accelerates impregnation.

The second roller unit 500 includes a plurality of rollers provided to narrow the width of the tow prepreg 21 fed out from the impregnation unit 300. Each of these rollers is configured to have a middle portion having a smaller diameter than the diameters of respective end portions, so as to narrow the width of the tow 20. The winder 600 is also called rewinder. The winder 600 is a device configured to wind the tow prepreg 21 fed out from the second roller unit 500. Winding by the winder 600 completes manufacture of the tow prepreg 21.

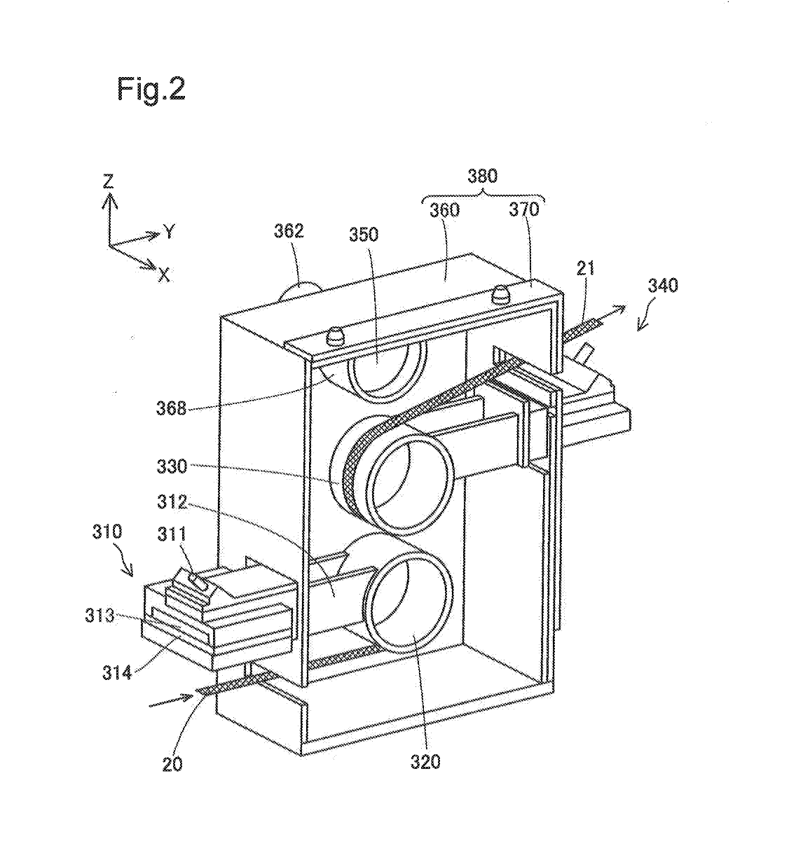

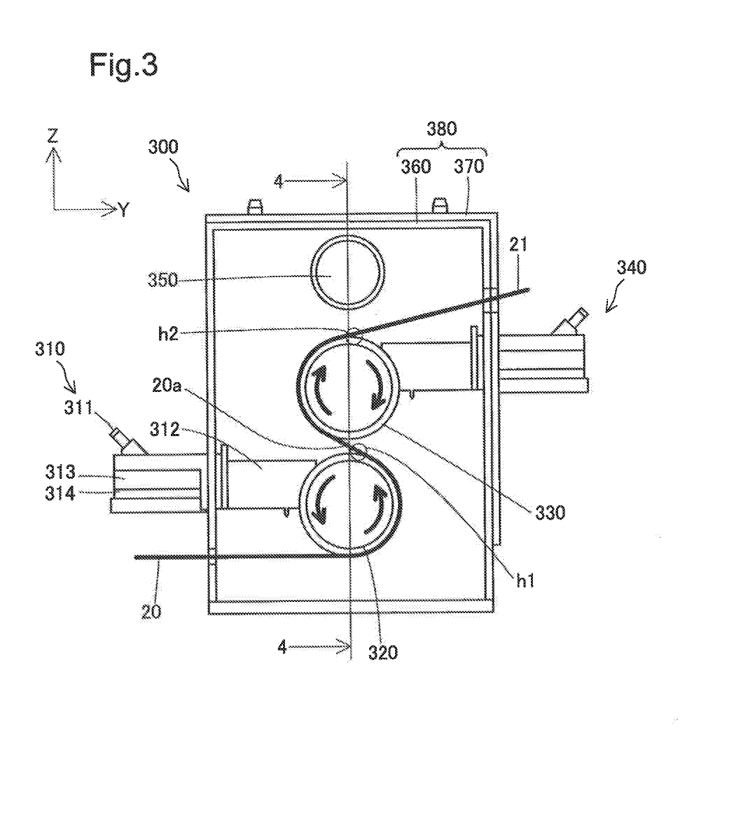

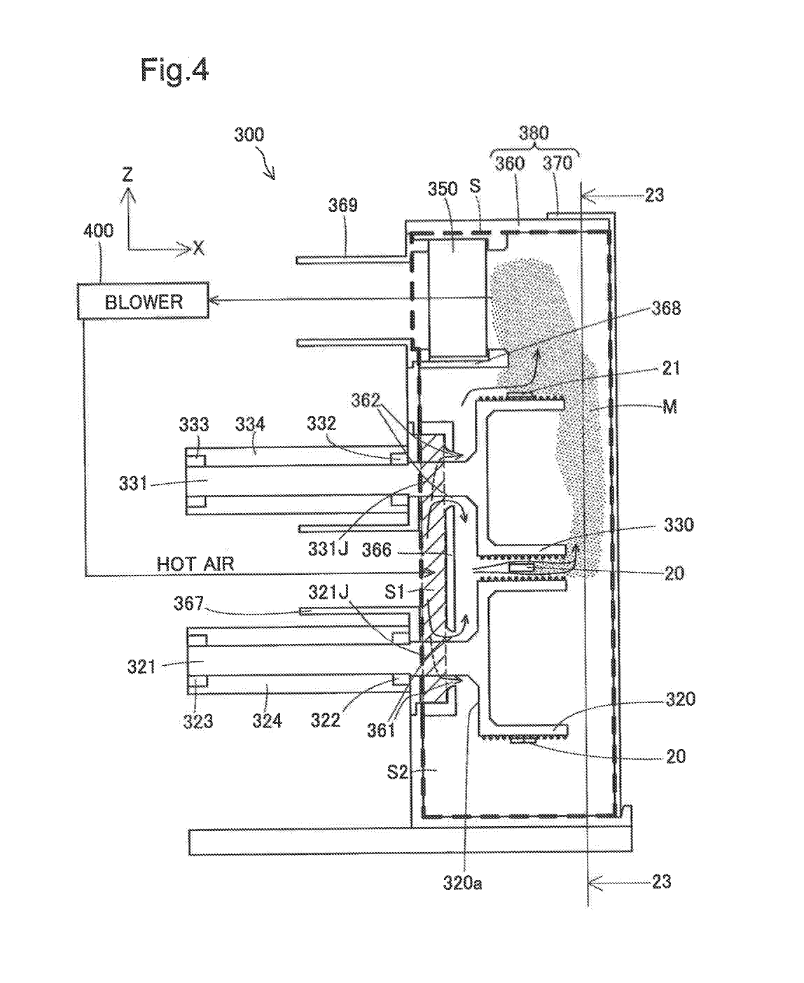

FIG. 2 is a sectional perspective view illustrating the impregnation unit 300. FIG. 3 is a sectional view illustrating the impregnation unit 300. FIG. 4 is a sectional end view illustrating the impregnation unit 300. The section shown in FIG. 2 and the section shown in FIG. 3 are a 23-23 section shown in FIG. 4. The sectional end face shown in FIG. 4 is a 4-4 sectional end face shown in FIG. 3. Impregnation is described below with reference to FIGS. 2, 3 and 4.

The impregnation unit 300 includes a first supply portion 310, a first impregnation roller 320, a second impregnation roller 330, a second supply portion 340, a filter 350, a separation member 360 and a cover 370.

The first supply portion 310 is configured to supply a resin to the surface of the first impregnation roller 320. The first supply portion 310 includes an inlet port 311, a resin reservoir-integrated doctor blade 312, a panel heater 313 and a position adjustment mechanism 314.

The inlet port 311 is a through hole provided to supply the resin to the resin reservoir-integrated doctor blade 312. The resin reservoir-integrated doctor blade 312 is configured to apply the resin supplied from the inlet port 311 on the surface of the first impregnation roller 320 by the doctor blade method. The resin is thus supplied to the surface of the first impregnation roller 320.

The panel heater 313 is located below the resin reservoir-integrated doctor blade 312 and is configured to heat the resin reservoir-integrated doctor blade 312 and thereby raise the temperature of the resin accumulated in the resin reservoir-integrated doctor blade 312. The position adjustment mechanism 314 is a mechanism configured to adjust the position of the resin reservoir-integrated doctor blade 312 relative to the first impregnation roller 320.

The first impregnation roller 320 is rotated to convey the tow 20. The rotation of the first impregnation roller 320 causes the conveyed tow 20 to be impregnated with the resin supplied by the first supply portion 310.

The second impregnation roller 330 and the second supply portion 340 have similar functions to those of the first impregnation roller 320 and the first supply portion 310 and are not described in detail herein. The tow 20 passing through the second impregnation roller 330 is conveyed as the tow prepreg 21 to the second roller unit 500.

The separation member 360 and the cover 370 constitute a housing 380. More specifically, mounting the cover 370 to the separation member 360 provides the housing 380. The cover 370 is demountable from the separation member 360 and is mountable to the separation member 360. The housing 380 provides a storage space S to place the first impregnation roller 320 and the second impregnation roller 330 therein. The rough outline of the storage space S is shown by a broken line in FIG. 4.

As shown in FIG. 4, the separation member 360 includes a partition plate 366. The partition plate 366 is arranged to separate an inlet space S1. The inlet space S1 is shown by hatching in FIG. 4. The inlet space S1 is part of the storage space S. A remaining part of the storage space S excluding the inlet space S1 is called main space S2. The inlet space S1 is connected with an intake port 367. The partition plate 366 has a first through hole 361 and a second through hole 362.

As shown in FIG. 4, the first impregnation roller 320 is connected with a first rotating shaft member 321. The first rotating shaft member 321 is arranged to penetrate the outer wall of the separation member 360 and the first through hole 361. More specifically, the connection part of the first impregnation roller 320 and the first rotating shaft member 321 is located in the main space S2 (i.e., inside of the storage space S), while the other end portion of the first rotating shaft member 321 that is opposite to the connection part is located outside of the storage space S. As described above, part of the first rotating shaft member 321 is located inside of the storage space S, while the remaining part of the first rotating shaft member 321 is located outside of the storage space S.

The first rotating shaft member 321 is held on a first bearing base 324 via a bearing 322 and a bearing 323. The first bearing base 324 is fixed to the surface of the separation member 360. This configuration allows the first impregnation roller 320 and the first rotating shaft member 321 to freely rotate accompanied with the conveyance of the tow 20. The bearings 322 and 323 and bearings 332 and 333 (described later) according to this embodiment are rolling bearings and more specifically roller hearings. The bearing 322 is placed to be in contact with the outer surface of the separation member 360.

The bearing 322 and the bearing 323 are located outside of the storage space S. Accordingly the separation member 360 is provided to separate the bearing 322 and the bearing 323 from the first impregnation roller 320 and the second impregnation roller 330.

The second impregnation roller 330 is connected with a second rotating shaft member 331. The second rotating shaft member 331 is arranged to penetrate the outer wall of the separation member 360 and the second through hole 362. More specifically, the connection part of the second impregnation roller 330 and the second rotating shaft member 331 is located inside of the storage space S, while the other end portion of the second rotating shaft member 331 that is opposite to the connection part is located outside of the storage space S.

The second rotating shaft member 331 is held on a second bearing base 334 via a bearing 332 and a bearing 333. The second bearing base 334 is fixed to the surface of the separation member 360. This configuration allows the second impregnation roller 330 and the second rotating shaft member 331 to freely rotate. The bearing 332 is placed to be in contact with the outer surface of the separation member 360.

The bearing 332 and the bearing 333 are located outside of the storage space S. Accordingly the separation member 360 is provided to separate the bearing 332 and the hearing 333 from the first impregnation roller 320 and the second impregnation roller 330.

The blower 400 is configured to blow the heated air into the inlet space S1 through the intake port 367 provided in the separation member 360. The air blown into the inlet space S1 is divided into a flow going toward the first through hole 361 and a flow going toward the second through hole 362. The air flowing toward the first through hole 361 is blown to a connection part 321J and then passes through the first through hole 361. The connection part 321J denotes a joint part of the housing 380 and the first rotating shaft member 321. The air flowing toward the second through hole 362 is blown to a connection part 331J and then passes through the second through hole 362. The connection part 331J denotes a joint part of the housing 380 and the second rotating shaft member 331.

The air passing through the first through hole 361 or the second through hole 362 flows into the main space S2. The air flowing into the main space S2 is blown in a direction opposite to the bearing 322 and the bearing 332 to the surface of at least part of the first impregnation roller 320 and the second impregnation roller 330 and subsequently flows toward an exhaust port 369 provided in the separation member 360. The air flowing toward the exhaust port 369 passes through the filter 350 and is discharged out of the main space 82 (i.e., out of the storage space S) through the exhaust port 369. The filter 350 adsorbs an atomized resin M (described later). The filter 350 is held by a filter holder 368 provided in the separation member 360.

The blower 400 sucks the air from the exhaust port 369. The blower 400 heats the sucked air by the heater 410 and is again blown from the intake port 367 into the storage space S.

A first separating part h1 shown in FIG. 3 indicates a location where an intermediate body 20a separates from the first impregnation roller 320. The intermediate body 20a denotes a tow that is after impregnation by the first impregnation roller 320 but prior to impregnation by the second impregnation roller 330. The intermediate body 20a separates from the first impregnation roller 320 at the first separating part h1, so that the resin is atomized and scatters from the surfaces of the intermediate body 20a and the first impregnation roller 320. This is shown as atomized resin M in FIG. 4.

A second separating part h2 shown in FIG. 3 indicates a location where the tow prepreg 21 separates from the second impregnation roller 330. The tow prepreg 21 separates from the second impregnation roller 330 at the second separating part h2, so that the atomized resin M scatters around the second separating part h2.

The atomized resin M is unlikely to adhere to the bearing 322 and the bearing 333. This is because the air sent from the blower 400 is blown to the connection part 321J and the connection part 331J. The filter 350 serves to remove the resin from the air blown by the blower 400. The atomized resin generated from the vicinity of the surfaces of the first impregnation roller 320 and the second impregnation roller 330 is flowed in a direction opposite to the bearing 322 and the bearing 332 by this air flow. As a result, the resin is unlikely to adhere to the bearing 322 and the bearing 333.

The atomized resin M is unlikely to flow out of the main space S2 through the first through hole 361 and the second through hole 362. This is because the direction of the air flow in the first through hole 361 and the second through hole 362 is the direction from outside to inside of the main space 52 as described above. Accordingly the atomized resin M adheres to the wall surface or the like in the main space S2 or is adsorbed by the filter 350. As a result, the atomized resin M is unlikely to flow into the inlet space S1 and adhere to the connection part 321J and the connection part 321J. This configuration accordingly suppresses the hearing 323 and the bearing 333 from being stained with the resin.

The first through hole 361 is formed to have a diameter smaller than the outer diameter of the first impregnation roller 320. The air flowing in through the first through hole 361 is accordingly blown to a bottom face 320a. The bottom face 320a is part of the first impregnation roller 320 and is a circular flat plate provided to connect a cylindrical surface (side face) of the first impregnation roller 320 with the first rotating shaft member 321.

The air flowing in through the first through hole 361 is the hot air and accordingly heats the bottom face 320a. Heating the bottom face 320a results in heating the entire first impregnation roller 320. The second impregnation roller 330 is similarly heated by the hot air blown from the second through hole 362.

Most part of the storage space S is isolated from the atmosphere, so that blowing in the heated air raises the internal temperature of the storage space S to be higher than the ambient temperature. This results in making the temperatures of the first impregnation roller 320 and the second impregnation roller 330 more likely to be stabilized.

As described above, the configuration of this embodiment is especially advantageous in terms of achieving the two advantageous effects, i.e., suppressing the bearings 322 and 332 from being stained and heating the first impregnation roller 320 and the second impregnation roller 330, by blowing the hot air into the storage space S.

The following describes an experimental example. This experimental, example produced fifty bobbins, each of which 2500 m of the tow prepreg 21 was wound on, under the following conditions. The results of this experiment have proved that no resin adhered to the bearing 322 and 332, in addition to successful completion of the production. A conventional configuration, on the other hand, caused the bearings to be stained in production of every ten bobbins.

The resin used for impregnation was an epoxy resin. The viscosity of the resin during impregnation was not lower than 2 pascal seconds and not higher than 3 pascal seconds. The tow 20 used was CF36K (tow consisting of 36000 filaments). The content of the resin in the tow prepreg 21 was not lower than 22% and not higher than 26%. The feed rate of the tow 20 was set to 100 m/minute. The outer diameters of the first impregnation roller 320 and the second impregnation roller 330 were set to 80 mm. Chromium-plated steel was employed for the material of the first impregnation roller 320 and the second impregnation roller 330. The temperature of the air blown into the intake port 367 was set to 40° C. The temperatures of the first impregnation roller 320 and the second impregnation roller 330 accordingly reached 40° C. in 15 minutes after a start of the air blowing. The volume flow rate of the air blown into the intake port 367 was set to 1 m³/minute.

The advantageous effects described above may be achieved, for example, by even changing at least one of the conditions as follows. The viscosity of the resin during impregnation may be set to be not lower than 1 pascal second and not higher than 10 pascal seconds. The content of the resin may be set to be not lower than 15%. The feed rate of the tow 20 may be set to not lower than 20 m/minute. Any of aluminum, stainless steel and ceramic may be employed for the material of the first impregnation roller 320 and the second impregnation roller 330.

The invention is not limited to any of the embodiment, the examples and the modifications described above but may be implemented by a diversity of other configurations without departing from the scope of the invention. For example, the technical features of any of the embodiment, the examples and modifications corresponding to the technical features of each of the aspects described in Summary may be replaced or combined appropriately, in order to solve part or all of the problems described above or in order to achieve part or all of the advantageous effects described above. Any of the technical features may be omitted appropriately unless the technical feature is described as essential herein. Some examples of possible modifications are given below.

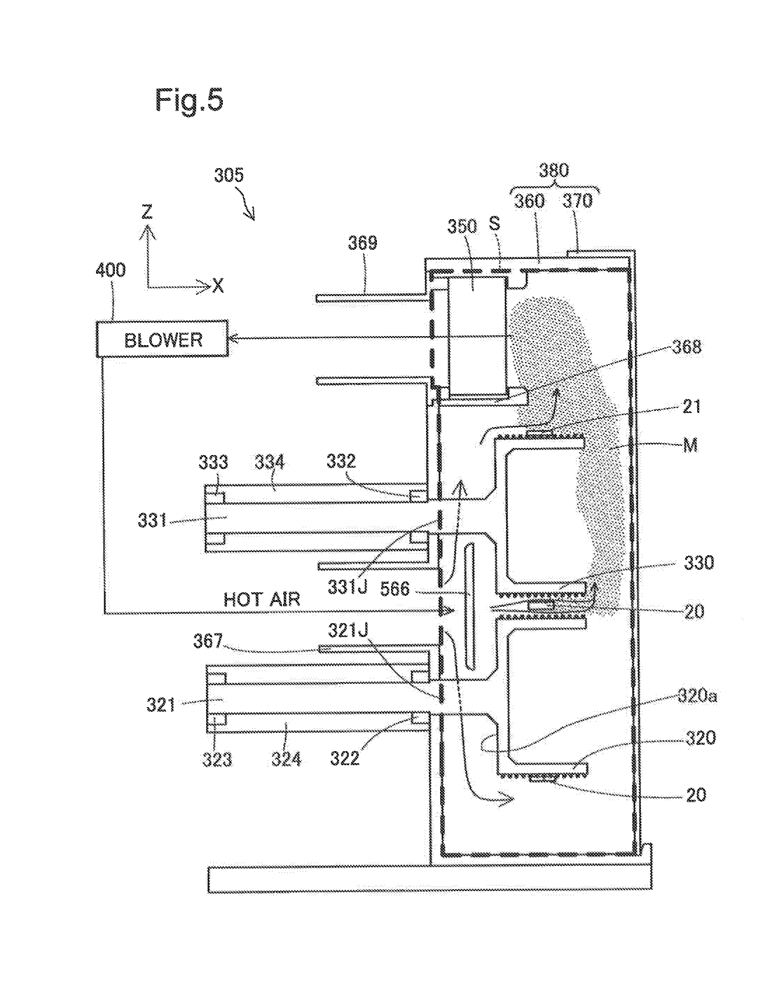

FIG. 5 is a sectional end view illustrating another impregnation unit 305. The impregnation unit 305 includes a partition plate 566, in place of the partition plate 366 provided in the impregnation unit 300 of the embodiment. The partition plate 56$ is placed between the first rotating shaft member 321 and the second rotating shaft member 331. The partition plate 566 is open below the first rotating shaft member 321 and above the second rotating shaft member 331.

The air blown from the intake port 367 enters between the outer wall of the separation member 360 and the partition plate 566. The partition plate 566 changes the direction of the air flow and divides the air flow into a downward flow and an upward flow. The air flowing downward is blown to the connection part 321J. The air flowing upward is blown to the connection part 331J. The air blown to the connection part 321J or to the connection part 331J flows toward the exhaust port 369.

The configuration of the impregnation unit 305 also causes the atomized resin generated from the vicinity of the surfaces of the first impregnation roller 320 and the second impregnation roller 330 to be flowed in a direction opposite to the bearing 322 and the bearing 332. Additionally, the configuration of the impregnation unit 305 causes the air sent from the blower 400 to be blown to the connection part 321J and to the connection part 331J. This results in suppressing the bearing 322 and the bearing 332 from being stained.

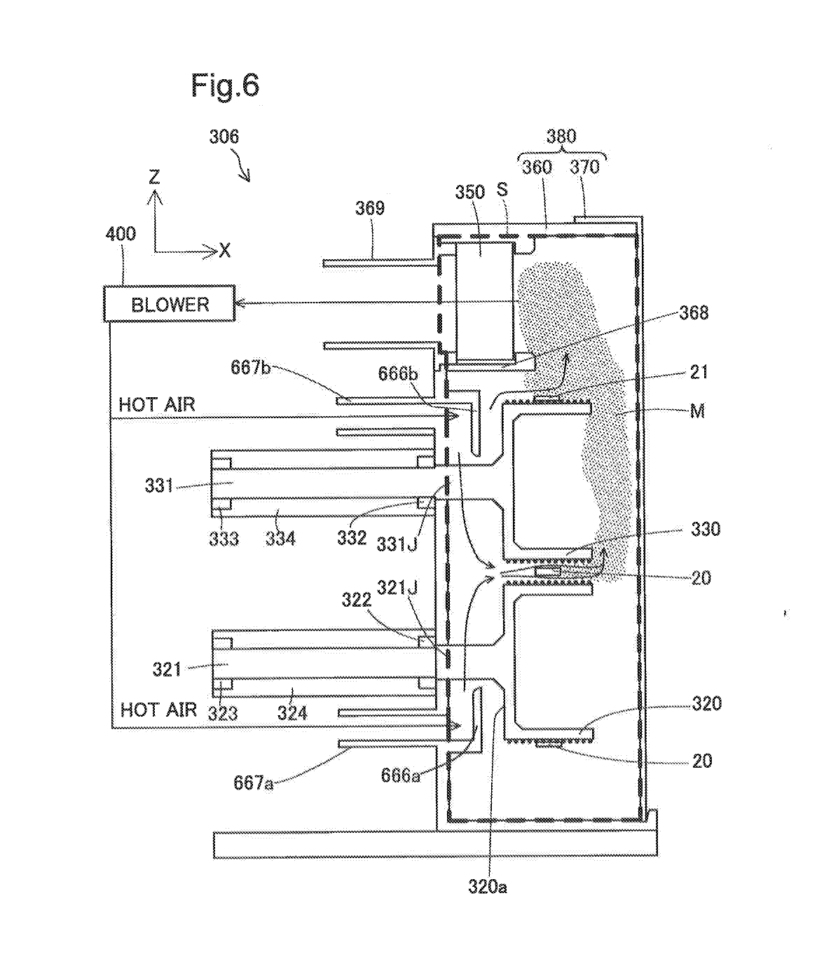

FIG. 6 is a sectional end view illustrating another impregnation unit 306. The impregnation unit 306 includes an intake port 667a and an intake port 667b, in place of the intake port 367 provided in the impregnation unit 300 of the embodiment. The impregnation unit 306 also includes a partition plate 666a and a partition plate 666b, in place of the partition plate 366 provided in the impregnation unit 300 of the embodiment. There is an opening between the partition plate 666a and the partition plate 666b.

The intake port 667a is provided below the first rotating shaft member 321. The partition plate 666a is placed below the first rotating shaft member 321. The air blown from the intake port 667a enters between the outer wall of the separation member 360 and the partition plate 666a. The partition plate 666a changes the direction of the air flow to an upward flow, so that the air is blown to the connection part 321J.

The intake port 667b is provided above the second rotating shaft member 331. The partition plate 666b is placed above the second rotating shaft member 331. The air blown from the intake port 667b enters between the outer wall of the separation member 360 and the partition plate 666b. The partition plate 666b changes the direction of the air flow to a downward flow, so that the air is blown to the connection part 331J. The air blown to the connection part 321J or to the connection part 331J flows toward the exhaust port 369.

The configuration of the impregnation unit 306 also causes the atomized resin generated from the vicinity of the surfaces of the first impregnation roller 320 and the second impregnation roller 330 to be flowed in a direction opposite to the bearing 322 and the hearing 332. Additionally, the configuration of the impregnation unit 306 causes the air sent from the blower 400 to be blown to the connection part 321J and to the connection part 331J. This results in suppressing the bearing 322 and the bearing 332 from being stained.

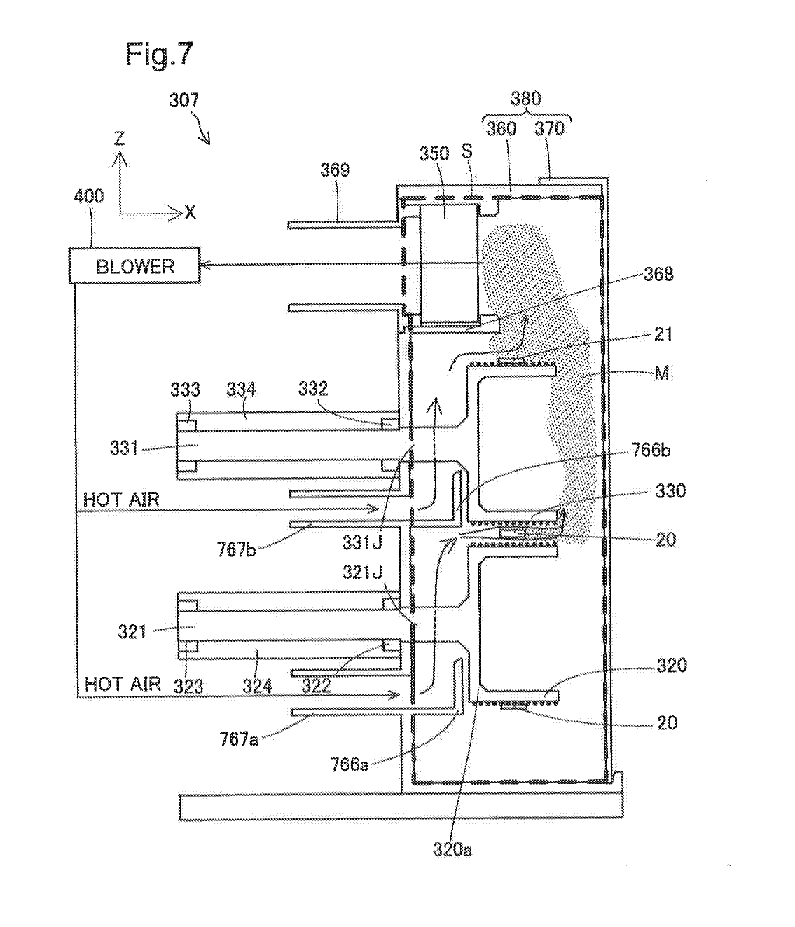

FIG. 7 is a sectional end view illustrating another impregnation unit 307. The impregnation unit 307 includes an intake port 767a and an intake port 767b, in place of the intake port 367 provided in the impregnation unit 300 of the embodiment. The impregnation unit 307 also includes a partition plate 766a and a partition plate 766b, in place of the partition plate 366 provided in the impregnation unit 300 of the embodiment.

The intake port 767b is provided between the first rotating shaft member 321 and the second rotating shaft member 331. The partition plate 766b is placed between the first rotating shaft member 321 and the second rotating shaft member 331. The air blown from the intake port 767b enters between the outer wall of the separation member 360 and the partition plate 766b. The inflow air flows upward and is blown to the connection part 331J. The air blown to the connection part 331J flows toward the exhaust port 369.

The intake port 767a is provided below the first rotating shaft member 321. The partition plate 766a is placed below the first rotating shaft member 321. The air blown from the intake port 767a enters between the outer wall of the separation member 360 and the partition plate 766a. The partition plate 766a changes the direction of the air flow to an upward flow, so that the air is blown to the connection part 321J. The partition plate 766b changes the direction of the flow of the air blown to the connection part 321J, so that the air flows between the first impregnation roller 320 and the second impregnation roller 330 and subsequently flows toward the exhaust port 369.

The configuration of the impregnation unit 307 also causes the atomized resin generated from the vicinity of the surfaces of the first impregnation roller 320 and the second impregnation roller 330 to be flowed in a direction opposite to the bearing 322 and the bearing 332. Additionally, the configuration of the impregnation unit 307 causes the air sent from the blower 400 to be blown to the connection part 321J and to the connection part 331J. This results in suppressing the bearing 322 and the bearing 332 from being stained.

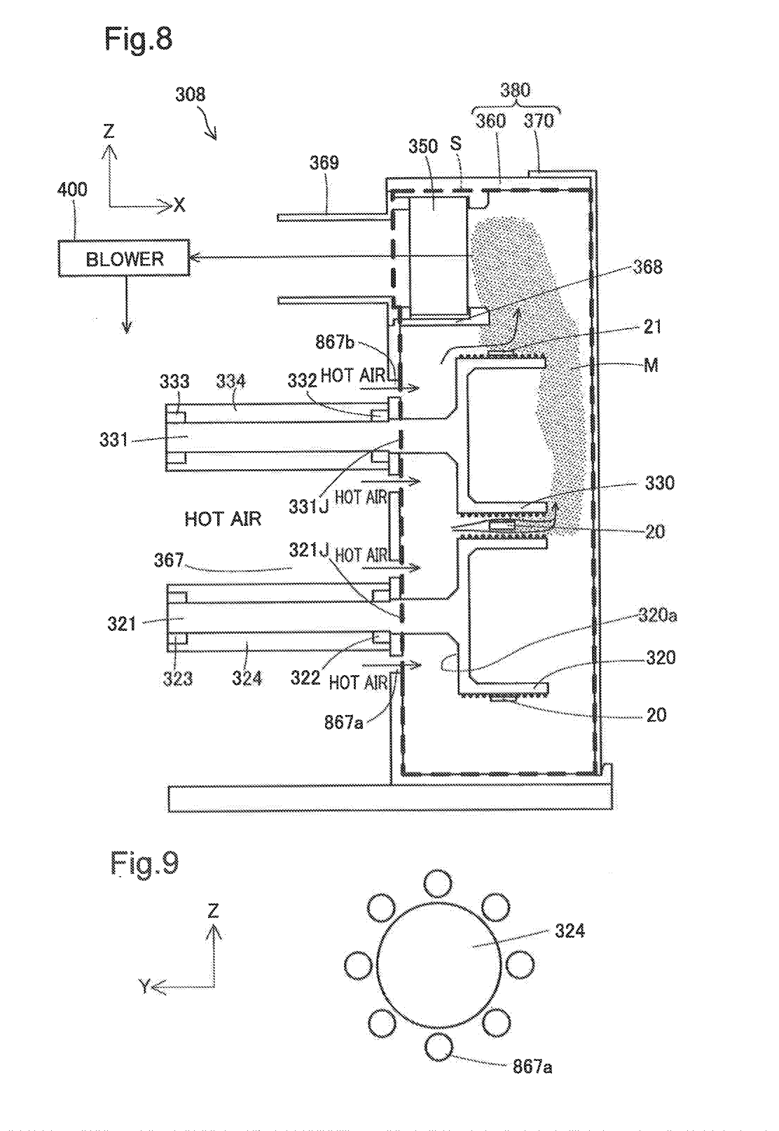

FIG. 8 is a sectional end view illustrating another impregnation unit 308. The impregnation unit 308 includes a plurality of intake ports 867a and a plurality of intake port 867b, in place of the intake port 367 provided in the impregnation unit 300 of the embodiment. The impregnation unit 308 does not include the partition plate 366.

FIG. 9 is a diagram illustrating the plurality of intake ports 867a viewed from outside of the housing 380. The plurality of intake ports 867a are arranged to surround the first bearing base 324.

The configuration of the impregnation unit 308 also causes the atomized resin generated from the vicinity of the surfaces of the first impregnation roller 320 and the second impregnation roller 330 to be flowed in a direction opposite to the bearing 322 and the bearing 332. This results in suppressing the bearing 322 and the bearing 332 from being stained.

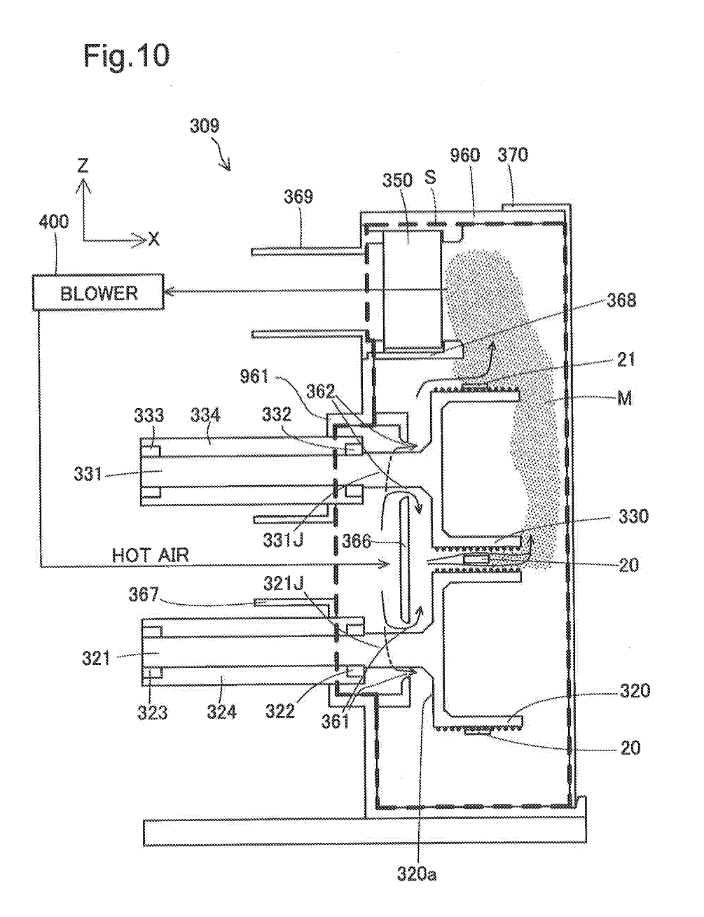

FIG. 10 is a sectional end view illustrating another impregnation unit 309. The impregnation unit 309 includes a wall 960, in place of the separation member 360 provided in the impregnation unit 300 of the embodiment.

The wall 960 has a protruded portion 961. The protruded portion 961 is extended to expand the storage space S. Parts of the first bearing base 324 and the second bearing base 334 are placed inside of the storage space S. Accordingly the bearing 322 and the bearing 332 are placed inside of the storage space S.

The configuration of the impregnation unit 309 also causes the atomized resin generated from the vicinity of the surfaces of the first impregnation roller 320 and the second impregnation roller 330 to be flowed in a direction opposite to the bearing 322 and the bearing 332. Additionally, the configuration of the impregnation unit 309 causes the air sent from the blower 400 to be blown to the connection part 321J and to the connection part 331J. This results in suppressing the bearing 322 and the bearing 332 from being stained.

Other possible modifications are provided below.

The number of the impregnation rollers may be only one or may be three or more.

The blower may be configured not to heat the air. In this modification, another means may be provided to heat the first and the second impregnation rollers. For example, the first and the second impregnation rollers may be heated by induction heating.

The blower may blow a gas other than the air. For example, using an inert gas such as nitrogen suppresses deterioration of the resin due to oxidation or the like.

The diameters of the first and the second through holes may be equal to or larger than the outer diameters of the first and the second impregnation rollers. In this modification, the diameters of the rotating shaft members may be equal to or larger than the outer diameters of the first and the second impregnation rollers. In this modified configuration, blowing in the heated air raises the internal temperature of the storage space, so as to heat the first and the second impregnation rollers.

The blower may be configured not to circulate the air. In this modification, the air blown from the first and the second through holes may be released to the atmosphere through the exhaust port.

The intake port may not be provided in the separation member but may be provided in another part of the housing. For example, the intake port may be provided in the cover.

The tow prepreg manufacturing apparatus may not include the first roller unit.

The tow prepreg manufacturing apparatus may not include the second roller unit.

The impregnation unit may not include the filter.

Unlike the embodiment described above, a fiber-reinforced composite material may be manufactured by impregnating a pitch-based carbon fiber or glass fiber with a resin.

The hearings may be ball bearings or slide bearings.

The bearing is not limited to the configuration of freely rotating in both directions like the above embodiment but may be configured to convey the tow by rotating in one direction.

The bearing base may not be fixed to the surface of the separation member but may be, for example, fixed by using a stand.

What is claimed is:

1. A manufacturing apparatus for a fiber-reinforced composite material, comprising:
a roller that is rotated to convey a fiber and impregnate the fiber with a resin, in order to manufacture the fiber-reinforced composite material from the fiber;
a supply portion that is configured to supply the resin to a surface of the roller;
a rotating shaft member that is connected with the roller;
a bearing that is configured to support the rotating shaft member such that the rotating shaft member is rotated about an axial direction of the rotating shaft member, accompanied with rotation of the roller;
a housing that has an intake port provided to take in a gas and an exhaust port provided to discharge the gas and that is configured to place part of the rotating shaft member and the roller inside thereof; and
a blower that is configured to blow the gas from the intake port into the housing, wherein
the gas taken in from the intake port is blown in a direction opposite to the bearing to at least part of the surface of the roller and is subsequently discharged out of the housing through the exhaust port.

2. The manufacturing apparatus for the fiber-reinforced composite material according to claim 1,
wherein the bearing is placed outside of the housing, and
the gas taken in from the intake port is blown to a connection part of the housing and the rotating shaft member and is subsequently blown to the surface of the roller.

3. The manufacturing apparatus for the fiber-reinforced composite material according to claim 2, wherein
the housing includes a partition plate provided to separate inside of the housing,
a space separated by the partition plate is connected with the intake port, and
the rotating shaft member is arranged to penetrate a through hole provided in the partition plate, wherein
at least part of the taken-in gas is blown to the connection part and subsequently passes through the through hole to be blown to the roller.

4. The manufacturing apparatus for the fiber-reinforced composite material according to claim 1,
wherein the blower heats the gas before blowing the gas.

5. The manufacturing apparatus for the fiber-reinforced composite material according to claim 4,
wherein the blower blows the gas discharged from the exhaust port into the intake port, so as to circulate the gas.

6. The manufacturing apparatus for the fiber-reinforced composite material according to claim 1,
wherein the housing includes a filter provided to adsorb the resin, wherein
the gas taken in from the intake port passes through the filter and is subsequently discharged out of the housing through the exhaust port.

7. The manufacturing apparatus for fiber-reinforced composite material according to claim 1,
wherein the bearing is supported on a bearing base fixed to a surface of the housing.

8. A manufacturing method of a fiber-reinforced composite material,
the manufacturing method comprising:
using a roller that is rotated to convey a fiber and impregnate the fiber with a resin, in order to manufacture the fiber-reinforced composite material from the fiber; a supply portion that is configured to supply the resin to a surface of the roller; a rotating shaft member that is connected with the roller; a bearing that is configured to support the rotating shaft member such that the rotating shaft member is rotated about an axial direction of the rotating shaft member, accompanied with rotation of the roller; a housing that has an intake port provided to take in a gas and an exhaust port provided to discharge the gas and that is configured to place part of the rotating shaft member and the roller inside thereof; and a blower that is configured to blow the gas from the intake port into the housing; and
causing the gas taken in from the intake port to be blown in a direction opposite to the bearing to at least part of the surface of the roller and to be subsequently discharged out of the housing through the exhaust port.
